(19) United States
(12) Patent Application Publication
(10) Pub. No.: US 2006/0212265 A1
(43) Pub. Date: Sep. 21, 2006

(54) Method and system for assessing quality of search engines

(75) Inventors: Einat Amitay, Shimshit (IL); Adam Darlow, Haifa (IL); Uri Weiss, Haifa (IL)

Correspondence Address: Stephen C. Kaufman;IBM CORPORATION., Intellectual Property Law Dept., P.O. Box 218, Yorktown Heights, NY, 10598, US

(73) Assignee: International Business Machines Corporation, Armonk, NY (US)

(21) Appl. No.: 11/083,204

(22) Filed: Mar. 17, 2005

(51) Int. Cl. G21C 17/00

(52) U.S. Cl. 702/182

(57) ABSTRACT

A method and system for assessing the quality of one or more search engines are provided. The method and system monitor reformulation sessions by users (201) of a search engine (308, 402, 403) by retrieving data from a query log (307, 407, 408), wherein a reformulation session is a series of at least two queries to a search engine (308) issued by a user (201) to satisfy a single information need. The method and system then determine a reformulation session parameter for the search engine (308, 402, 403) and analyse the reformulation session parameter. The reformulation session parameter may be a rate of query reformulations in a reformulation session or a reformulation session duration. Analysing the reformulation session parameter for a single search engine may determine if the parameter changes with time or may determine the parameter with different settings in a single search engine. Analysing the reformulation session parameter for two or more search engines includes comparing the parameters of the two or more search engines to measure the search quality. The analysis can be used to control the operation of one or more search engines.

### TECHNICAL FIELD

This invention relates to the field of information search and retrieval. In particular, this invention relates to assessing the quality of search engines by using information extracted from query logs.

### BACKGROUND OF THE INVENTION

There are three communities of people involved in searching the World Wide Web. There are authors, who contribute all of the content to the Web. There are searchers, who use search engines to find the content which interests them. Finally, there are developers who create and maintain the search engines. The three communities overlap at times and people often belong to several communities according to their needs.

Search engine users bring into the search process knowledge that may not be documented within the collection, may not be addressed by developers and dealt with in the ranking function, and may be considered irrelevant by all other searchers but the one who submits the query. As illustrated in FIG. 1, the overlap between the world knowledge of the users 102 and the single view of the search engine 101 through its collection and search processes differs from one individual user 102 to the next. Some users may agree on how they describe a concept but not on which query best captures that description. Other users will ask exactly the same query and will expect to find different things entirely. Some people will choose to use very limiting syntax in their queries asking the engine to adhere to their requests. Others may develop a sense of trust in the engine and will let it decide how the query should be processed.

This notion of search engine trustworthiness is essential to the interactions with search engines. It dictates the way people approach the search process and how long they are willing to probe the searchable collection to find answers. The perception of search engines as machines with a different view of the world leads search engine users to start small negotiations about their information needs. Users may try to ask the same question with different flavours and foci to come to a conclusion that they have done all that is possible and that they have reached the maximum information within the searchable volume.

There are many search engines on the Internet each with its own method of operating. Generally search engines include: at least one spider or crawler application which crawls across the Internet gathering information; a database which contains all the information the crawler gathers in the form of an index or catalogue; and a search tool for users to search through the database. Search engines extract and index information differently and also return results in different ways.

Internet technology is also used to create private corporate networks call Intranets. Intranet networks and resources are not available publicly on the Internet and are separated from the rest of the Internet by a firewall which prohibits unauthorised access to the Intranet. Intranets also have search engines which search within the limits of the Intranet.

In addition, search engines are provided in individual Web sites, for example, of large corporations. A search engine is used to index and retrieve the content of only the Web site to which it relates and associated databases and other resources.

U.S. patent application Ser. No. 10/743,158, filed Dec. 23, 2003, recognizes that there is a significant amount of information in users' queries about how users view the items for which they are searching and provides a system in which query words are joined to information in the index of a search engine thereby increasing the ways in which an item may be described.

Users of search engines often do not find what they are looking for with the first query they issue. Some users then alter their initial queries in various ways, perhaps by adding or removing terms, and resubmit them.

From the searcher's perspective, having to reformulate queries worsens the user experience. In addition, each time an employee has to spend extra time reformulating queries in an Intranet search engine, the company suffers directly from financial loss. Therefore, the quantity and length of sessions found in a query log can be a valuable measure of search quality.

Search engine users employ several distinctive methods to negotiate their path through the information mismatch. This negotiation is typically called query reformulation, although other terms are also used.

Query reformulation is different from query refinement. Query reformulation is an action exclusively taken by a single human user to find desired information. Query refinement, on the other hand, is an automatic process that many retrieval systems use in order to enhance the user query to best match it to the indexed information. It may be that search engines hide this from the user or that they ask the user to choose the best refinement, nevertheless, query refinement is still automatic in nature. Query reformulation stems from the search engine user's perception of the world, and query refinement stems from the search engine's perception of the world.

Reformulations usually occur within a known period of time and with a single search engine. They are grouped in sessions which are termed reformulation sessions. The definition of a reformulation session is a series of at least two queries issued by a user in order to satisfy a single information need. An example might consist of the queries, “hershy park”, “hershy park pa” and finally “hershey park pa”. Although paging through the results may be considered to be a kind of reformulation, if the only type of reformulation the user does is paging, it is not considered to be a reformulation in this context.

The factors which influence the length of sessions are many, including the search algorithm, the quality of the collection, users' search expertise and even users' patience. However, when all other factors are constant, a search engine whose query log analysis reveals a higher session rate and/or longer sessions should be considered to be of poorer quality. The same comparison could be used for different content made available for search.

A problem with search engines is the need to provide a measure of the performance of an individual search engine or across more than one search engine. It is an aim of the present invention to provide a solution to this problem by providing quality assessment of one or more search engines by monitoring query reformulations. It is a further aim to control the operation of one or more search engines based on the analysis of query reformulations.

### SUMMARY OF THE INVENTION

According to a first aspect of the present invention there is provided a method for assessing the quality of one or more search engines, comprising: monitoring reformulation sessions by users of a search engine, wherein a reformulation session is a series of at least two queries to a search engine issued by a user to satisfy a single information need; determining a reformulation session parameter for the search engine; and analysing the reformulation session parameter.

The method may optionally include controlling the operation of a search engine based on the analysis.

The reformulation session parameter may be a rate of query reformulations in a reformulation session as calculated by the number of queries that are part of a reformulation session. divided by the total number of queries in a query log. Another reformulation session parameter may be reformulation session duration as calculated by the number of queries per reformulation session or the time duration of a reformulation session. Statistical method may be applied to the reformulation session parameters.

The reformulation session parameter may relate to the nature or trend of the content of the reformulated query. For example, the use of synonyms, misspellings, expanded terms and contracted terms.

The reformulation session parameter may relate to the nature or trend in the use of syntax in the reformulated query. For example, the use of minus, plus and quote signs.

The method may include logging data relating to reformulation sessions in a log, externally or internally to the search engine.

The step of monitoring reformulation sessions may include identifying reformulation queries within a threshold time or threshold similarity and grouping the queries together as a reformulation session.

Analysing the reformulation session parameter may include determining if the parameter changes with time for a single search engine or determining the parameter with different settings in a single search engine. The monitoring may be carried out after an update of a data collection being searched. Controlling the operation of the search engine may control the operating parameters of a single search engine.

Analysing the reformulation session parameter may include comparing the parameters of two or more search engines. Controlling the operation of the search engine may select a search engine for use from two or more search engines.

Controlling the operation of the search engine may involve one or more of the following: provide an alert if a reformulation session parameter changes outside a predetermined threshold; start a crawler operation for the search engine; control the operation of the search engine adds an input query term to a query refinement process; determine user input instructions; or start an index change in a search engine.

According to a second aspect of the present invention there is provided a system for assessing the quality of one or more search engines, comprising: a query log of queries submitted by users of a search engine; means for monitoring reformulation sessions by users of the search engine, wherein a reformulation session is a series of at least two queries to the search engine issued by a user to satisfy a single information need; means for determining a reformulation session parameter for the search engine; and means for analysing the reformulation session parameter.

The system may optionally include means for controlling the operation of a search engine based on the analysis.

The query log may be provided in the search engine or externally to the search engine. The system may include means for retrieving data from the query log.

The means for analysing the reformulation session parameter includes determining if the parameter changes with time for a single search engine or determining the parameter with different settings in a single search engine. The means for monitoring may be carried out on an updated data collection being searched.

The system may include two or more search engines and the means for analysing the reformulation session parameter may include comparing the parameters of the two or more search engines.

The search engine may be an Internet search engine, an Intranet search engine, a Web site search engine, or a search engine dedicated to any collection of documents.

According to a third aspect of the present invention there is provided a computer program product stored on a computer readable storage medium, comprising computer readable program code means for performing the steps of: monitoring reformulation sessions by users of a search engine, wherein a reformulation session is a series of at least two queries to a search engine issued by a user to satisfy a single information need; determining a reformulation session parameter for the search engine; and analysing the reformulation session parameter.

The computer program product may also include controlling the operation of a search engine based on the analysis.

According to a fourth aspect of the present invention there is provided a system for controlling the operation of one or more search engines, comprising: means for receiving an analysis of reformulation sessions by users of the search engine, wherein a reformulation session is a series of at least two queries to the search engine issued by a user to satisfy a single information need; and means for controlling the operation of a search engine based on the analysis.

The means for controlling the operation of the search engine may control the operation by providing means for one or more of the following: selecting a search engine for use from two or more search engines; providing an alert if a reformulation session parameter changes outside a predetermined threshold; starting a crawler operation for the search engine; adding an input query term to a query refinement process; determining user input instructions; or providing an index change in a search engine.

### BRIEF DESCRIPTION OF THE DRAWINGS

Embodiments of the present invention will now be described, by way of examples only, with reference to the accompanying drawings in which:

FIG. 1 is a schematic diagram illustrating the world of knowledge as it is perceived by a search engine and its users;

FIG. 2 is a block diagram of an example Web architecture;

FIG. 3 is a block diagram of a search engine architecture which may be used in accordance with the present invention;

FIG. 4 is block diagram of a system in accordance with the present invention; and

FIG. 5 is a flow diagram of a method in accordance with the present invention.

### DESCRIPTION OF PREFERRED EMBODIMENTS

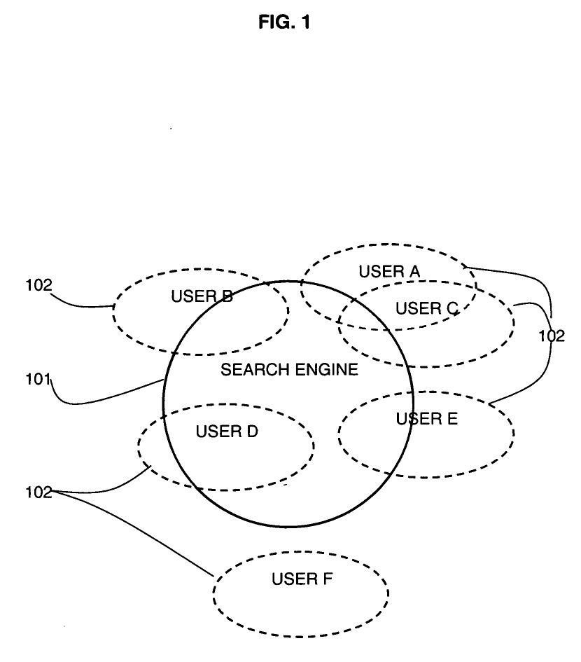

As discussed above FIG. 1 illustrates the differing knowledge base of individual users 102 of a search engine and the knowledge of the search engine itself 101. A user of a search engine approaches a search query from their knowledge base. Therefore, reformulations of the query are often needed before the search engine retrieves the information that the user is looking for. Reformulations of a single query are referred to as reformulation sessions. The described method and system use the information provided by reformulation sessions of users to assess the quality of search engines.

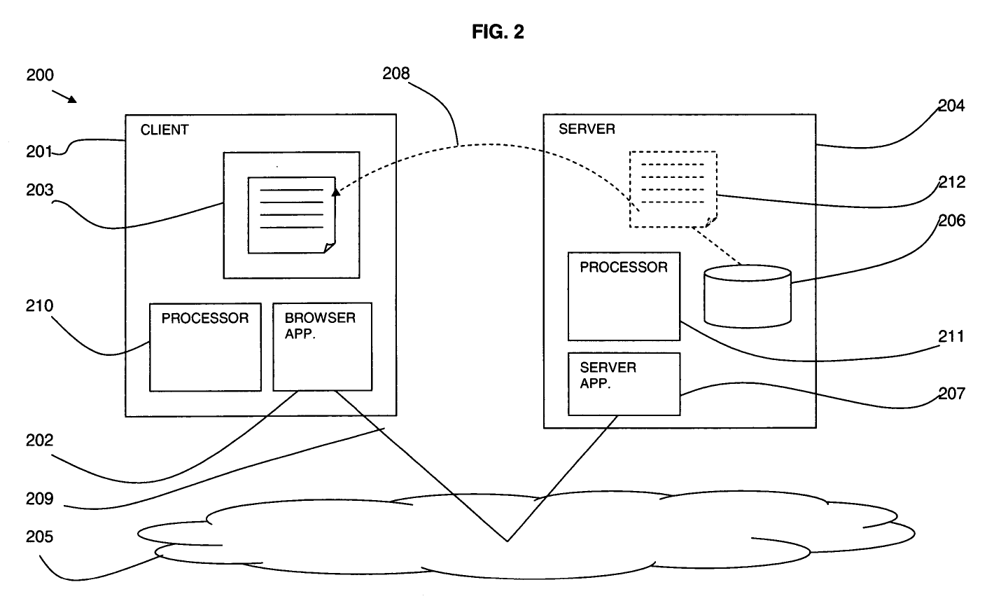

Referring to FIG. 2, an example embodiment of a Web architecture 200 is shown. A client computer system 201 generally comprises a central processing unit (CPU) 210, with an operating system, memory, input/output interface, bus, input/output devices. The client computer system 201 includes a browser application 202 which interacts with a host server system 204 via a connection 209 (for example, a TCP (Transmission Control Protocol) connection) using a network 205 (for example, the Internet). The client computer system 201 includes a graphical user interface (GUI) 203 which displays information provided by the browser application 202.

The host server system 204 has the function of sending information to the client computer system 201 as requested by the browser application 202. The host server system 204 is a computer system generally comprising a central processing unit (CPU) 211, with an operating system, and a database 206. The host server system 201 includes a server application 207 which handles requests from the browser application 202 of the client computer system 201 and communications with the host operating system. The host server system 204 is an HTTP (Hypertext Transfer Protocol) server which sends information to the client browser application 202 using HTTP transfer 208. In the context of the World Wide Web, the host server system 204 is a Web server.

Generally, the client browser application 202 requests that the host server system 204 return an HTML (Hypertext Markup Language) document. The host server system 204 receives the request and sends back a response. The host server system 204 retrieves the requested information 212 from its database 206 and sends the information 212 to the client browser application 202 which displays the information 212 in the client's GUI 203.

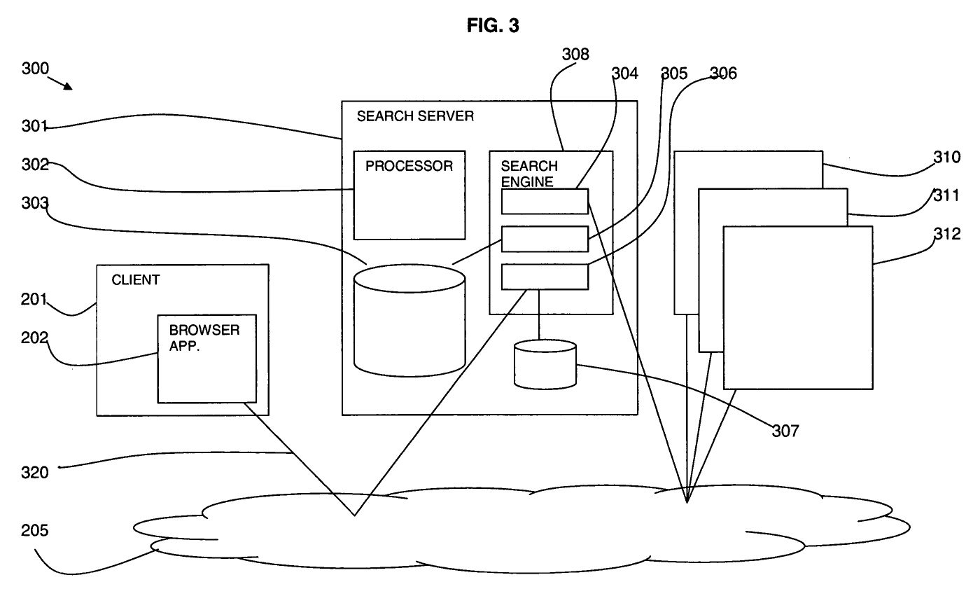

Referring to FIG. 3, an example embodiment of a search engine system 300 is shown. A server system 301 is provided generally including a central processing unit (CPU) 302, with an operating system, and a database 303. A server system 301 provides a search engine 308 including: a crawler application 304 for gathering information from servers 310, 311, 312 via a network 205; an application 305 for creating an index or catalogue of the gathered information in the database 303; and a search query application 306.

The index stored in the database 303 references URLs (Uniform Resource Locator) of documents in the servers 310, 311, 312 with information extracted from the documents.

The search query application 306 receives a query request 320 from a client 201 via the network 205, compares it to the entries in the index stored in the database 303 and returns the results in HTML pages. When the client 201 selects a link to a document, the client's browser application 202 is routed straight to the server 310, 311, 312 which hosts the document.

The search query application 306 keeps a query log 307 of the search queries received from clients using the search engine 303. Alternatively, a query log may be kept separately from the search engine 300 by saving queries in a log first and then sending the information to the search engine 300.

The best way to learn about query reformulations by a client is by analysing the query log 307 of a search engine 303. In order to investigate reformulations in a query log 307, the log 307 must first be divided into reformulation sessions. The method used to extract these depends upon what information the query log 307 provides for each query in addition to its text and timestamp. The additional information that is relevant is identification of either individual sessions or individual users.

The described embodiment focuses on the scenario where no additional information is provided and it does not rely on anything outside the search engine itself. An example of such a scenario is an out-of-the-box search engine which assumes no knowledge of the application running it.

The best case is if a search engine keeps session information in its log, actually tracking when a user returns to a page of search results and alters the query. In this case, no extra processing need be done and the grouping of queries into reformulation sessions is straightforward. Although, some users may pursue several information needs within a single recorded session in which case these may need to be divided.

A more common possibility is that a log contains information identifying its users with some identifier, such as an IP (Internet Protocol) address. In this case, the assumption is made that after a user issues a query, all other queries they issue within a short time frame will be reformulations of that query. Once the time limit has been determined, the grouping of queries can be done with a straightforward algorithm. In many cases, even if an IP address is known, it cannot be used to identify a single user, such as requests that go through a proxy. In such cases, the sessions will have to be approximated as described below.

Often a query log will not contain any information for identifying users. With such a log, the sessions can only be approximated by finding queries in the log which are likely to be reformulations of other queries.

Making the observation that most reformulations leave much of the query unchanged, approximate string matching algorithms are used. One form of algorithm which works well is tf*idf weighted trigram matching. The Jaro-Winkler algorithm also performed well and was investigated. This method is unable to discover reformulations where the user completely rewrites the query.

Simply described, the reformulation session extraction algorithm is given two thresholds, a time threshold and a similarity threshold. A series of queries is grouped into a single session if all occur within the time threshold and each two consecutive queries are within the similarity threshold.

```
Sessions <- Ø
Log <- { all queries ordered by time }
while (Log != Ø)
  Q1 <- remove first query from Log
  Q_start <- Q1
  New Session <- {Q1}
  for each Q2 in Log
    if (time(Q2) − time(Q_start) < time threshold)
      if (compare(Q1, Q2) < similarity threshold)
        New Session <- New Session U {Q2}
        Log <- Log \ {Q2}
        Q1 = Q2
  if (|New Session| > 1)
    Sessions <- Session U {New Session}
```

In the example given below, the findings reported in this analysis were achieved with a time threshold of ten minutes. Various window sizes were experimented with from five minutes up to 30 minutes and it was found that the values were almost identical across all time thresholds in terms of length, duration and duration distribution. The only value that changed with time threshold was the percentage of reformulations sessions out of the whole query log, which increased slightly with the increase in time. The ten minute time threshold was used since it is both representative of the query reformulation characteristics and also more reliable in terms of extraction mistakes. For example, it is less likely that the same query will be submitted by several different users within a very short time frame. The shorter the time frame the more accurate the session extraction and the faster the processing.

### EXAMPLE

This example traces the exploration of both Intranet and Web query logs of two different search engines with two very different user communities: an Intranet search engine of a computer corporation, and an external Web site search engine of the same computer corporation. The Intranet search engine receives about half a million queries every month exclusively from the corporation's employees. The external Web site receives in the order of several millions of queries every month from the corporation's customers around the world.

The logs analysed here were taken from two different search engines with two different user communities. The Intranet search engine was sampled and nearly 200,000 queries logged in several different days. The public Web site was logged for just a single week and collected over 500,000 queries. The Intranet search log was produced from the main machine; the public Web site search log was taken from two different machines which are part of a cluster of several. The users of the two search engines are different in nature. The Intranet users are very technically aware, while the public Web site search engine users come to purchase products, to look for technical support, and to learn about the corporation's financial situation.

The following are examples of session parameters which can be analysed and comparisons which may be made between search engines to assess quality or to obtain information regarding user behaviour.

The rate of reformulation in each of the Intranet search logs were analysed. The logging was limited to about 25,000 queries per log. The percentage of queries in sessions was calculated by the number of queries found to be part of a reformulation divided by the total number of queries in the log.

Simply taking the average of the logs from the different engines yielded strikingly similar results, with 31.7% of the queries submitted to the Intranet search engine being part of reformulation sessions, and 31.3% queries being part of reformulation sessions on the public Web site search engine.

The variations between the working days was also analysed and compared between the search engines.

Reformulation session length measured in queries per session is one indication for the time people are willing to spend interacting with search engines. Since included in the computed sessions were all occurrences of “next page” of results as well as reformulations of the query (but each session was required to have at least one reformulation), indications can also be provided about the process of deciding to change the query altogether rather than to browse the results served by the search engine.

In each log the sample variance and standard deviation of the number of queries per session was monitored.

The average number of queries per session in the Intranet and in the public Web site were also compared.

One factor that may contribute to explaining the slight difference between the two different engines is the rate of browsing through the search results. Since the “next results page” is counted to be a new issuance of a query in a session, the difference between the rate of browsing the Intranet search results and the public site search results was also measured.

The rate for the general log which includes all the queries issued to the search engine is about 14% to 16% for both the Intranet and the public Web site. This finding indicates a positive correlation between a user browsing the search results and issuing a query reformulation.

Reformulation session duration is the measure of how long the user chose to negotiate the information need with the search engine. To achieve this the time stamp of the first and the last queries in each session was used to calculate session duration.

The consistency of the medians and average duration of reformulation sessions on the logs was compared.

An average number of queries per session may be taken and divided by session duration to approximate the time that an average user will spend per query, browsing the search results and deciding whether the information need was satisfied or not. This parameter can be compared between search engines.

Reformulations of queries reflect the users' perception of the search engine. Users unknowingly try two different approaches to tackling the problem of finding information. One way is trying to decipher how the authors' community describes the concept within the collection. The other method is tantamount to trying to reverse engineer the way the search engine developers' community chose to rank and parse the collected information. The first approach is comparable to conversing with the authors, using content reformulations, and the second, with the developers, using syntax reformulations. This division helps provide a better understand the issues each of the approaches raises. The content and syntax reformulations can also be detected and analysed.

Content-related reformulations can be of several types: looking for synonymous terms, simply misspelling terms, expanding the query to narrow down the search scope, and simplifying the query to broaden the search scope.

Syntax reformations include the insertion of search operators such as minus, plus and quotes signs in queries.

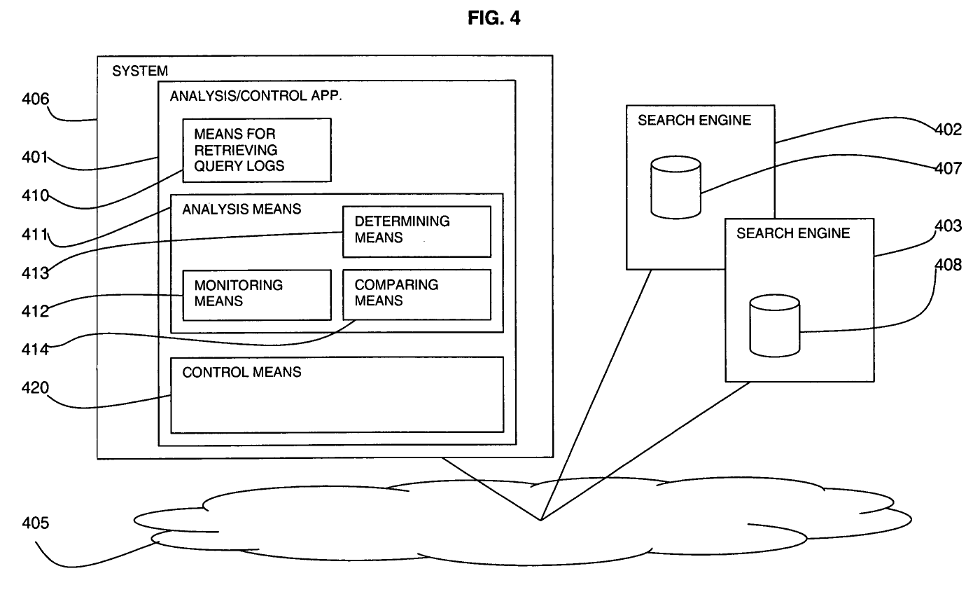

Referring now to FIG. 4, a system 406 is shown as an example embodiment of the present invention. The system 406 includes an application 401 for analysis and control of one or more search engines 402, 403. The application 401 (or series of applications) may be provided on a client system or a server system remotely via a network 405 or locally to the one or more search engines 402, 403 under analysis. As in the example given above, the search engines 402, 403 under analysis may be Internet search engines, public Web site search engines, Intranet search engines, a search engine dedicated to any collection of documents, or a combination of the above.

The application 401 includes a means 410 for retrieving query logs 407, 408 for one or more search engines 402, 403 under analysis. The query logs 407, 408 are shown in this example embodiment as being internal to the search engines 402, 403; however, the query logs 407, 408 may be provided externally to the search engines, for example on user systems or external servers. The query logs analysed may be taken from a subset of machines provided in a cluster comprising a search engine. The application 401 includes analysis means 411 for analysing the data from the query logs 407, 408. The analysis means 411 includes means for monitoring reformulation sessions 412, means for determining a session rate or other session parameter 413 and comparing means 414. The application 401 may contain other forms of data manipulation depending on the analysis required.

The application 401, in one example embodiment, also includes a control means 420 for controlling the search engines 402, 403 under analysis. The control means 420 may alternatively, be provided separately from the analysis means 411, for example, on another system local or remote from the search engines 402, 403. The control means 420 can control the search. engines 402, 403 in accordance with one or more of the following operations based on the results of the analysis.
The control means 420 can select a search engine from a plurality of search engines based on the analysis.
The control means 420 may select operating parameters for a single search engine based on analysis of one search engine.
The control means 420 may issue an alert if a parameter of reformulation sessions being monitored changes according to preset thresholds.
The control means 420 may start a crawler application is the analysis indicates repeatedly unrecognised input queries requiring reformulation.
The control means 420 may add an input query term automatically to a query refinement process of a search engine if the analysis identifies a repeatedly corrected term in query reformulations.
The control means 420 may choose instructions to include in a user interface (for example, such as query syntax examples) based on the analysis of the syntax parameters in query reformulations.
The control means 420 may start an index change based on high reformulation rates of query reformulations.

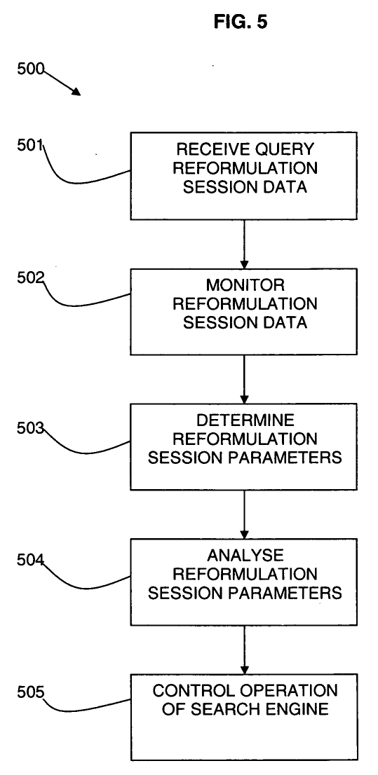

FIG. 5 is a flow diagram 500 of a method of analysing reformulation sessions as carried out by one or more computer processes. Query reformulation session data is received 501 from query logs. The data is monitored 502 and predefined reformulation session parameters are determined 503. The monitoring and determination 502, 503 may be carried out for a finite period of time or may be ongoing. The determined parameters are analysed 504 and the operation of one or more search engines is controlled 505 based on the outcome of the analysis.

A simple quality test for a search engine would be to monitor the query log to measure the rate of reformulations of queries. If the rate increases through time then this requires a more comprehensive analysis of the nature of the reformulations. Another way of using the reformulation rate measure is to compare the performance of two different search engines or the same search engine with different settings on the same collection and with the same user community. It is assumed that the better search engine or search settings will require less reformulation efforts from users. It is also possible to run a reformulation rate analysis after regular updates of the index to see whether users miss some content that was there before and was not indexed, or is named differently.

The analysis of reformulation sessions also reveals a rich source for content enhancement. For example, it may be that users are mostly calling a product with its old and familiar name while the index only contains information labelled with the new product name. This is a very common problem that can be spotted fairly easily by analysing the reformulations list. This important information can be forwarded to the site editors, with a suggestion to add the terms to their existing content.

By analysing sessions, terms and topics can be discovered which are not covered in the searchable collection. This information enables the collection to be enhanced by adding new documents and new content.

Knowing which queries and isolated terms were searched but not easily found or not found at all can provide evidence that a focused crawl may be required. A crawler can be configured to prefer documents containing desired terms which were extracted from the reformulation sessions. Also, the crawler can be set to visit new sites which were identified as containing the terms from the reformulation sessions.

It is also possible that the information users were looking for is simply missing and a more rigorous analysis may indicate that there is a “hole” in the searchable information. In this case, new content should be created to satisfy the information need.

The administrator of a searchable collection can identify topics which are not covered in the collection by analysing repeatedly reoccurring reformulation sequences. Then, the administrator may instruct that new content be written to cover the topics. Such content may also be purchased or acquired, e.g. help files, drivers' support pages, etc. This scenario can also be envisioned in an online retail store where new trends are identified from the sessions and the current inventory is expanded to satisfy demand.

Reformulation sessions discovered in the query log can also be used as candidates for query refinement. If several users issuing similar queries ended up reformulating them before they were satisfied with the results, it is likely that more users will have similar difficulties. A search engine can automatically suggest those reformulations as refinements, taking advantage of the detective work that the previous users already did. This approach is more user-centric than current approaches to query refinement, which generally decide what refinements to suggest based upon the content the search engine has indexed.

The reformulation session information found in query logs can be analysed with no assumptions regarding user information stored in the log. The information gained from them can be utilized in many ways to enhance user experience and improve Web content. It can also be used as a measure of quality for either a search engine or the content it has indexed.

The present invention is typically implemented as a computer program product, comprising a set of program instructions for controlling a computer or similar device. These instructions can be supplied preloaded into a system or recorded on a storage medium such as a CD-ROM, or made available for downloading over a network such as the Internet or a mobile telephone network.

Improvements and modifications can be made to the foregoing without departing from the scope of the present invention.

We claim:

1. A method for assessing the quality of one or more search engines, comprising:
monitoring reformulation sessions by users of a search engine, wherein a reformulation session is a series of at least two queries to a search engine issued by a user to satisfy a single information need;
determining a reformulation session parameter for the search engine; and
analysing the reformulation session parameter.

2. THE method as claimed in claim 1, including controlling the operation of the search engine based on the analysis.

3. The method as claimed in claim 1, wherein the reformulation session parameter is one of the group of: a rate of query reformulations in a reformulation session; a reformulation session duration; the content of the reformulated query; or the syntax of the reformulated query.

4. The method as claimed in claim 1, wherein the step of monitoring reformulation sessions includes identifying reformulation queries within a threshold time and grouping the queries together as a reformulation session.

5. The method as claimed in claim 1, wherein the step of monitoring reformulation sessions includes identifying reformulation queries within a threshold similarity and grouping the queries together as a reformulation session.

6. The method as claimed in claim 1, wherein analysing the reformulation session parameter includes determining if the parameter changes with time for a single search engine.

7. The method as claimed in claim 1, wherein analysing the reformulation session parameter includes determining the parameter with different settings in a single search engine.

8. The method as claimed in claim 1, wherein controlling the operation of the search engine controls the operating parameters of a single search engine.

9. The method as claimed in claim 1, wherein analysing the reformulation session parameter includes comparing the parameters of two or more search engines.

10. The method as claimed in claim 1, wherein controlling the operation of the search engine selects a search engine for use from two or more search engines.

11. The method as claimed in claim 1, wherein controlling the operation of the search engine provides an alert if a reformulation session parameter changes outside a predetermined threshold.

12. The method as claimed in claim 1, wherein controlling the operation of the search engine starts a crawler operation for the search engine.

13. The method as claimed in claim 1, wherein controlling the operation of the search engine adds an input query term to a query refinement process.

14. The method as claimed in claim 1, wherein controlling the operation of the search engine determines user input instructions.

15. The method as claimed in claim 1, wherein controlling the operation of the search engine starts an index change in a search engine.

16. The method as claimed in claim 1, wherein the monitoring is carried out after an update of a data collection being searched.

17. A system for assessing the quality of one or more search engines, comprising:
a query log of queries submitted by users of a search engine;
means for monitoring reformulation sessions by users of the search engine, wherein a reformulation session is a series of at least two queries to the search engine issued by a user to satisfy a single information need;
means for determining a reformulation session parameter for the search engine; and
means for analysing the reformulation session parameter.

18. The system as claimed in claim 17, wherein the system includes means for controlling the operation of a search engine based on the analysis.

19. The system as claimed in claim 17, wherein the reformulation session parameter is one of the following group: a rate of query reformulations in a reformulation session; a reformulation session duration; the content of the reformulated query; or the syntax of the reformulated query.

20. The system as claimed in claim 17, wherein the query log is provided in the search engine.

21. The system as claimed in claim 17, wherein the query log is external to the search engine.

22. The system as claimed in claim 17, wherein the system includes means for retrieving data from the query log.

23. The system as claimed in claim 17, wherein the means for analysing the reformulation session parameter includes determining if the parameter changes with time for a single search engine.

24. The system as claimed in claim 17, wherein the means for analysing the reformulation session parameter includes determining the parameter with different settings in a single search engine.

25. The system as claimed in claim 17, wherein the system includes two or more search engines and the means for analysing the reformulation session parameter includes comparing the parameters of the two or more search engines.

26. The system as claimed in claim 17, wherein the search engine is an Internet search engine, an Intranet search engine, a Web site search engine, or a search engine dedicated to any collection of documents.

27. A computer program product stored on a computer readable storage medium, comprising computer readable program code means for performing the steps of:
monitoring reformulation sessions by users of a search engine, wherein a reformulation session is a series of at least two queries to a search engine issued by a user to satisfy a single information need;
determining a reformulation session parameter for the search engine; and
analysing the reformulation session parameter.

28. The computer program product as claimed in claim 27, including controlling the operation of a search engine based on the analysis.

29. A system for controlling the operation of one or more search engines, comprising:
means for receiving an analysis of reformulation sessions by users of the search engine, wherein a reformulation session is a series of at least two queries to the search engine issued by a user to satisfy a single information need; and
means for controlling the operation of a search engine based on the analysis.

30. The system as claimed in claim 29, wherein the means for controlling the operation of the search engine selects a search engine for use from two or more search engines.

31. The system as claimed in claim 29, wherein the means for controlling the operation of the search engine provides an alert if a reformulation session parameter changes outside a predetermined threshold.

32. The system as claimed in claim 29, wherein the means for controlling the operation of the search engine includes means for starting a crawler operation for the search engine.

33. The system as claimed in claim 29, wherein the means for controlling the operation of the search engine includes means for adding an input query term to a query refinement process.

34. The system as claimed in claim 29, wherein the means for controlling the operation of the search engine includes means for determining user input instructions.

35. The system in claim 29, wherein the means for controlling the operation of the search engine includes means for providing an index change in a search engine.
